(19) United States
(12) Patent Application Publication
(10) Pub. No.: US 2005/0273425 A1
(43) Pub. Date: Dec. 8, 2005

(54) Acceptance/reception separating system in financial institution

(75) Inventor: Shinichi Yamazaki, Tokyo (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/143,494

(22) Filed: Jun. 3, 2005

(30) Foreign Application Priority Data
Jun. 4, 2004 (JP) 2004-166495

(51) Int. Cl. G06F 17/60

(52) U.S. Cl. 705/39

(57) ABSTRACT

An acceptance/reception separating system in a financial institution has: accepting means which accepts a process for a financial transaction; deposit receipt issuing means which issues a deposit receipt showing the acceptance of the process; business processing means which executes the process; notifying means which notifies the system of the end of the process; and receiving means which confirms a personal identification by the deposit receipt and enables a processing result to be received. The acceptance of the process and the reception of the processing result are separately executed. When the process for the financial transaction is accepted, the deposit receipt is issued to the customer. After the process, he can receive the processing result by the deposit receipt. A waiting time of the customer is shortened and customer services and processing efficiency can be improved.

### BACKGROUND OF THE INVENTION

1. Field of the Invention

The invention relates to an acceptance/reception separating system in a financial institution.

2. Related Background Art

Hitherto, in a service office of a financial institution such as bank, credit bank, post office, or the like managing office counter work, the visiting customer first receives a ticket with a paging number dispensed at a ticket dispensing machine and then waits until he is paged with the paging number seated on a waiting seat, or the like. When he is paged with the paging number, he visits a designated window, his business is accepted there, and processes for various financial transactions are executed. When the processes are finished, the customer receives a passbook such as a bankbook or the like, withdrawn money, and the like at the window (for example, refer to JP-A-2002-74006).

Thus, since the customer can be seated on the waiting seat and wait for his turn without making a line in front of the window, he does not need to feel fatigue. When the number of waiting persons, the paging number being accepted at the window at present, and the like are displayed on a display apparatus, he can presume a waiting time to a certain extent and does not need to feel mental stress.

However, in the above conventional system, since the processes for the various financial transactions are started after the business of the customer is accepted at the window, a series of processes such as confirmation of the business of the customer, his personal identification, and the like take time. Therefore, the time dealing with each customer at the window becomes very long, so that a waiting time of each customer waiting for his turn becomes long. Since the customer whose business has been accepted at the window also needs to receive the passbook such as a bankbook or the like, the withdrawn money, and the like at the window, he has to wait until the processes are finished. Also in view of an interest of the financial institution, the prolonged time dealing with the customers hinders improvement of efficiency of the office counter work.

### SUMMARY OF THE INVENTION

It is an object of the invention to solve the problems in the conventional system as mentioned above and to provide an acceptance/reception separating system in a financial institution, in which when a process for a financial transaction is accepted, a deposit receipt is issued to the customer and, after the end of the process, the customer is enabled to receive a result of the process by using the deposit receipt, a waiting time of the customer can be reduced, customer services can be improved, and processing efficiency in the financial institution can be improved.

According to the present invention, there is provided an acceptance/reception separating system in a financial institution, comprising:
accepting means which accepts a process for a financial transaction;
deposit receipt issuing means which issues a deposit receipt showing that the process has been accepted;
business processing means which executes the process;
notifying means which notifies the system of an end of the process; and
receiving means which confirms a personal identification by the deposit receipt and enables a result of the process to be received,
wherein the acceptance of the process and the reception of the result of the process are separately executed.

In the acceptance/reception separating system, the deposit receipt issuing means issues the deposit receipt by writing a receipt number into an IC card.

Moreover, in the acceptance/reception separating system, the notifying means notifies the system of the end of the process by transmitting E-mail to a customer terminal.

Moreover, in the acceptance/reception separating system, the receiving means is a reception-only terminal, a locker for reception, or an automatic cash transaction apparatus.

Moreover, in the acceptance/reception separating system, the deposit receipt is a certificate with an IC tag.

Moreover, in the acceptance/reception separating system, the deposit receipt is issued when the end of the process is notified.

Moreover, in the acceptance/reception separating system, the notifying means notifies the system of the end of the process by updating Internet information or displaying it onto a distributing board.

Moreover, in the acceptance/reception separating system, the accepting means accepts the process by Internet banking.

Moreover, in the acceptance/reception separating system, the accepting means accepts the process by telephone.

Moreover, in the acceptance/reception separating system, the accepting means accepts the process by an electronic book-keeping apparatus.

Moreover, in the acceptance/reception separating system, the receiving means is a reception-only terminal or a locker for reception.

Moreover, in the acceptance/reception separating system, the receiving means is a locker for reception.

Moreover, in the acceptance/reception separating system, the receiving means is a locker for reception or an automatic cash transaction apparatus.

According to the invention, in the acceptance/reception separating system in the financial institution, when the process for the financial transaction is accepted, the deposit receipt is issued to the customer and, after the end of the process, the customer can receive the result of the process by using the deposit receipt. Therefore, the waiting time of the customer can be reduced, the customer services can be improved, and the processing efficiency in the financial institution can be improved.

The above and other objects and features of the present invention will become apparent from the following detailed description and the appended claims with reference to the accompanying drawings.

### BRIEF DESCRIPTION OF THE DRAWINGS

FIG. 1 is a diagram showing an outline of the operation of an acceptance/reception separating system in a financial institution in the first embodiment of the invention;

FIG. 2 is a diagram showing a construction of the acceptance/reception separating system in a financial institution in the first embodiment of the invention;

FIG. 3 is a flowchart showing the operation at the time of acceptance in the acceptance/reception separating system in the financial institution in the first embodiment of the invention;

FIG. 4 is a first flowchart showing the operation at the time of reception in the acceptance/reception separating system in the financial institution in the first embodiment of the invention;

FIG. 5 is a second flowchart showing the operation at the time of reception in the acceptance/reception separating system in the financial institution in the first embodiment of the invention;

FIG. 6 is a diagram showing an outline of the operation of an acceptance/reception separating system in a financial institution in the third embodiment of the invention;

FIG. 7 is a diagram showing an outline of the operation of an acceptance/reception separating system in a financial institution in the fourth embodiment of the invention;

FIG. 8 is a diagram showing an outline of the operation of an acceptance/reception separating system in a financial institution in the fifth embodiment of the invention;

FIG. 9 is a diagram showing an outline of the operation of an acceptance/reception separating system in a financial institution in the sixth embodiment of the invention;

FIG. 10 is a diagram showing an outline of the operation of an acceptance/reception separating system in a financial institution in the seventh embodiment of the invention;

FIG. 11 is a diagram showing an outline of the operation of an acceptance/reception separating system in a financial institution in the eighth embodiment of the invention;

FIG. 12 is a diagram showing an outline of the operation of an acceptance/reception separating system in a financial institution in the ninth embodiment of the invention; and

FIG. 13 is a diagram showing an outline of the operation of an acceptance/reception separating system in a financial institution in the tenth embodiment of the invention.

### DETAILED DESCRIPTION OF THE PREFERRED EMBODIMENTS

Embodiments of the invention will be described in detail hereinbelow with reference to the drawings.

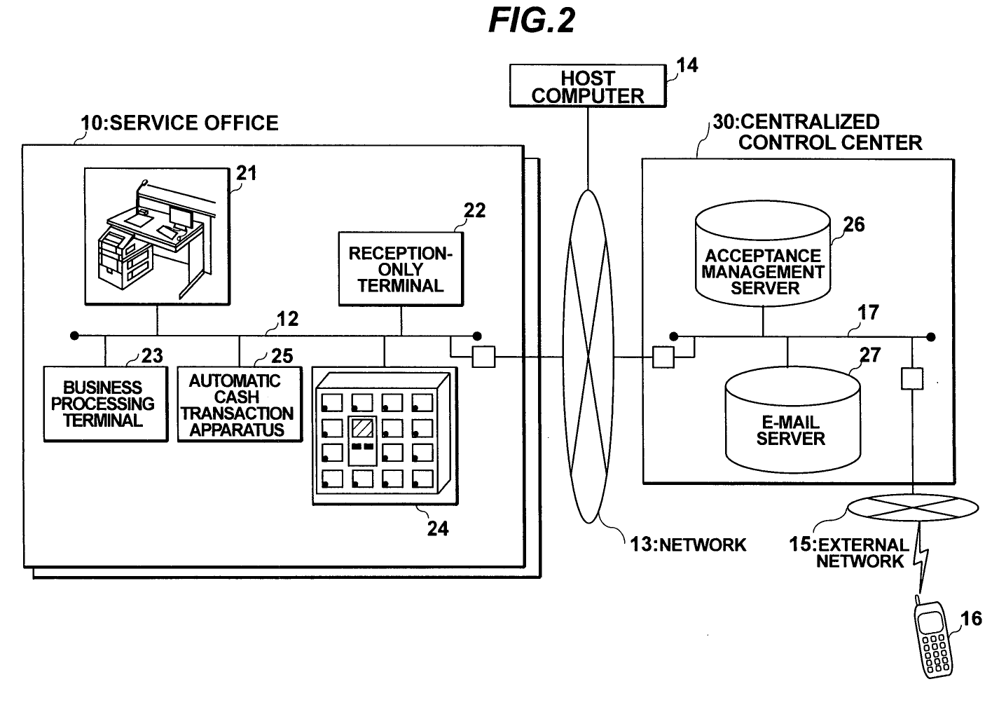

FIG. 2 is a diagram showing a construction of an acceptance/reception separating system in a financial institution in the first embodiment of the invention.

In the diagram, reference numeral 10 denotes a service office serving as a head office, a branch office, or the like of a financial institution such as bank, credit bank, post office, or the like. In the service office 10, there are provided: an acceptance-only terminal 21 as accepting means serving as a window terminal provided at the acceptance-only window; a reception-only terminal 22 as receiving means serving as a window terminal provided at the reception-only window; a business processing terminal 23 as business processing means serving as a terminal arranged behind the window; a locker 24 for reception as receiving means arranged in a receiving locker booth; and an automatic cash transaction apparatus 25 as receiving means such as ATM (Automatic Teller Machine), CD (Cash Dispenser; automatic cash paying machine), or the like arranged in an ATM booth.

The acceptance-only terminal 21 has a control unit, an input apparatus, a display apparatus, a scanner apparatus as an image input apparatus, and a medium processing apparatus. The control unit is a computer having arithmetic operating means such as CPU, MPU, or the like, storing means such as magnetic disk, semiconductor memory, or the like, a communication interface, and the like. The control unit integratedly controls all of the operations of the acceptance-only terminal 21 including the operations of the input apparatus, the display apparatus, the scanner apparatus, and the medium processing apparatus. A keyboard, a mouse, a push button, a touch panel, or the like can be given as an input apparatus. However, an arbitrary kind of input apparatus can be used so long as the person in charge at the acceptance-only window in the service office 10 can input necessary items by operating the apparatus. Further, a CRT, a liquid crystal display, an LED (Light Emitting Diode) display, or the like can be given as a display apparatus. However, an arbitrary kind of display apparatus can be used. For example, a touch panel also having a function of the input apparatus can be also used.

A flat bed scanner, a sheet feed scanner, a drum scanner, or the like can be given as a scanner apparatus. However, an arbitrary kind of scanner can be used. Although it is desirable to use a color scanner which can read a color image as a scanner apparatus, a monochromatic scanner can be used. The scanner apparatus has: for example, a light source constructed by a fluorescent lamp or the like for irradiating light onto a slip 32, which will be explained hereinafter; and an image sensor such as a line-type image sensor constructed by a CCD (Charge Coupled Device) for receiving the reflected light from the surface of the slip 32 and the like. The scanner apparatus reads an image of the slip 32, that is, obtains image data while scanning it.

The medium processing apparatus is an apparatus for processing a medium such as IC card 35, which will be explained hereinafter, issued to a customer 31 by the financial institution, passbook such as a bankbook or the like, cash 33 as a bill, check 34, or the like. The medium processing apparatus has a card slot through which the IC card 35 is inserted and ejected, a passbook slot through which the passbook is inserted and ejected, a cash receiving port through which payment and withdrawal of the cash 33 are executed, and the like. A conveying apparatus for conveying the IC card 35 and a recording head for executing the reading, overwriting, erasure, and the like of information stored in an IC are arranged in the card slot. A conveying apparatus for conveying the passbook, a print head for printing a record of the financial transaction onto the passbook, and a recording head for executing the reading, overwriting, erasure, and the like of information stored in a magnetic stripe or an IC of the passbook are arranged in the passbook slot. Further, a money payment/withdrawal apparatus for receiving the cash 33 paid by the customer 31 in the financial transaction such as payment or the like, counting it, and withdrawing the cash 33 of a predetermined money amount from the cash receiving port in the financial transaction such as withdrawal or the like is arranged in the cash receiving port. It is desirable that the money payment/withdrawal apparatus can also count negotiable securities such as a check 34 and the like.

It is preferable that the acceptance-only terminal 21 has: a slip recognizing function for recognizing a format of the slip 32 read by the scanner apparatus; an OCR (Optical Character Reader) function for recognizing characters written on the slip 32, and a seal collating function for collating a collation target impression of a seal with a collating source seal impression which has previously been registered. In this case, by the slip recognizing function, the acceptance-only terminal 21 extracts ruled lines, frames, and the like from the image data of the slip 32 read by the scanner apparatus, collates the ruled lines, frames, and the like with data registered in the storing means, identifies a kind of slip 32, and recognizes the format. By the OCR function, the acceptance-only terminal 21 reads character information written in the corresponding position in the format of the slip 32 from the image data of the slip 32 read by the scanner apparatus. Further, by the seal collating function, the acceptance-only terminal 21 extracts an impression of a seal, as a collation target seal impression, in a sealed column of the slip 32 from the image data of the slip 32 read by the scanner apparatus and collates the collation target seal impression with the collating source seal impression as a seal impression which has previously been registered in the storing means, thereby making the seal collation and confirming consistency between the collation target seal impression and the collating source seal impression.

By operating the acceptance-only terminal 21, the person in charge at the acceptance-only window in the service office 10 accepts various businesses such as financial process like payment, debit, change, or the like of the cash 33, opening of a new account, setting of a time deposit, issuance of a passbook, withdrawal of the cash 33, and the like. Although only one acceptance-only terminal 21 is shown in the diagram, a plurality of acceptance-only terminals 21 can be also provided.

The reception-only terminal 22 is a kind of computer which is operated by the person in charge at the reception-only window and has: an input apparatus such as keyboard, mouse, touch panel, or the like; a display apparatus such as CRT, liquid crystal display, LED display, or the like; arithmetic operating means such as CPU, MPU, or the like; storing means such as magnetic disk, semiconductor memory, or the like; a communication interface; and the like. The reception-only terminal 22 has an IC card processing apparatus. The IC card processing apparatus has a card slot through which the IC card 35 is inserted and ejected. A conveying apparatus for conveying the IC card 35 and a recording head for executing the reading, overwriting, erasure, and the like of the information stored in the IC are arranged in the card slot. The person in charge at the reception-only window in the service office 10 executes a business for returning a processing result of the slip 32, the cash 33, and the like to the customer 31 by operating the reception-only terminal 21. Although only one reception-only terminal 22 is shown in the diagram, a plurality of reception-only terminals 22 can be also provided.

Further, the business processing terminal 23 is a kind of computer which is operated by the person in charge who processes the businesses of the service office 10 and has: an input apparatus such as keyboard, mouse, touch panel, or the like; a display apparatus such as CRT, liquid crystal display, LED display, or the like; arithmetic operating means such as CPU, MPU, or the like; storing means such as magnetic disk, semiconductor memory, or the like; a communication interface; and the like. It is preferable that the business processing terminal 23 has: a slip recognizing function for recognizing the format of the slip 32 read by the scanner apparatus of the acceptance-only terminal 21; an OCR function for recognizing the characters written on the slip 32; and a seal collating function for collating the impression of the seal on the slip 32, that is, the collation target seal impression with the collating source seal impression which has previously been registered. By operating the business processing terminal 23, the person in charge who processes the businesses of the service office 10 executes the various businesses such as financial process like payment, debit, change, or the like of the cash 33, opening of a new account, setting of a time deposit, issuance of a passbook, withdrawal of the cash 33, and the like. Although only one business processing terminal 23 is shown in the diagram, a plurality of business processing terminals 23 can be also provided.

The locker 24 for reception is a kind of electronic locker and has a plurality of independent boxes for enclosing the slip 32, the cash 33, and the like. A locker door having an electronic lock is closably attached to a front cover of each box. The receiving locker 24 has a control unit for controlling the operation of the receiving locker 24. The control unit is a kind of computer having: arithmetic operating means such as CPU, MPU, or the like; storing means such as magnetic disk, semiconductor memory, or the like; an input/output interface; a communication interface; and the like. The control unit has: a card reading/writing unit for reading and writing information stored in the storing means of the IC card 35; operating means which is operated by the customer 31; an operation display apparatus constructed by a touch panel functioning as display means for displaying the information; and the like.

The automatic cash transaction apparatus 25 is a kind of computer having: arithmetic operating means such as CPU, MPU, or the like; storing means such as semiconductor memory, magnetic disk, or the like; a communication interface; and the like. The automatic cash transaction apparatus 25 has a customer operation unit comprising: an input apparatus such as keyboard, touch panel, or the like; a display apparatus such as CRT, liquid crystal display, LED display, or the like; a voice input apparatus such as a microphone or the like for inputting a voice sound of the customer 31; a voice output apparatus such as a speaker or the like for generating a voice guidance; and the like. The customer 31 can execute the financial transaction by operating the automatic cash transaction apparatus 25 by himself.

The automatic cash transaction apparatus 25 also has a card processing unit (not shown) for handling a card such as a cash card or the like. The card processing unit can also handle the IC card 35. The card processing unit has a card slot through which the card such as an IC card 35 or the like is inserted and ejected. A conveying apparatus for conveying the card and a recording head such as a magnetic head or the like for executing the reading, overwriting, erasure, and the like of information stored in the magnetic stripe or the IC of the card are arranged in the card slot.

Further, the card processing unit has a function of issuing a transaction itemized account as a slit 32. The transaction itemized account is a piece of paper on which information regarding the financial transaction executed by the customer such as payment, withdrawal, book-keeping, inquiry for the balance, transfer, change, remittance, setting of a time deposit, or the like is printed. An account number, a kind of financial transaction, a transaction money amount, and the like are printed.

The automatic cash transaction apparatus 25 also has a book-keeping unit (not shown) for writing a record onto a passbook such as a bankbook or the like. The passbook is a booklet-shaped passbook such as a bankbook or the like issued to the customer by the financial institution. A record of the financial transaction such as payment, withdrawal, transfer, change, remittance, setting of the time deposit, or the like is printed. A front or back cover of the passbook has a magnetic stripe for storing information such as name, account number, personal identification number, and the like of the customer 31. Further, in place of the magnetic stripe, an IC buried in the passbook can be also used as a member for storing the information.

The book-keeping unit has a passbook slot into which the passbook is inserted. A conveying apparatus for conveying the passbook, a print head for printing the record of the financial transaction onto the passbook, and a recording head such as a magnetic head or the like for executing the reading, overwriting, erasure, and the like of information stored in the magnetic stripe or the IC of the passbook are arranged in the passbook slot.

Further, the automatic cash transaction apparatus 25 has a money payment/withdrawal unit for handling the cash 33. The money payment/withdrawal unit receives the cash 33 paid by the customer 31 in the financial transaction such as a payment or the like, counts it, and ejects the cash 33 of a predetermined money amount in the financial transaction such as a withdrawal or the like from the cash receiving port. A shutter is closably attached to the cash receiving port. The shutter is opened when the cash 33 is ejected

The receiving locker 24 and the automatic cash transaction apparatus 25 are arranged on the floor in the service office 10 where the customer 31 can visit and receive the slip 32, the cash 33, and the like even after the end of the business hours at the windows in the service office 10.

Reference numeral 12 denotes a network in the service office such as Intranet, LAN (Local Area Network), or the like constructed in the service office 10. The acceptance-only terminal 21, reception-only terminal 22, business processing terminal 23, receiving locker 24, and automatic cash transaction apparatus 25 are connected to the network 12. Further, the network 12 in the service office is connected to a network 13 through a router or the like. Although a dedicated communication line network is preferable as a network 13, an arbitrary communication line network such as wired or wireless public communication line network, Internet, Intranet, LAN, WAN (Wide Area Network), VPN (Virtual Private Network), satellite communication line network, or the like can be given as a network 13 or a proper combination of them can be also used.

A host computer 14 as an upper apparatus for executing processes of an account system is arranged in a computer center or the like of the financial institution and connected to the network 13. The host computer 14 has: arithmetic operating means such as CPU, MPU, or the like; storing means such as semiconductor memory, magnetic disk, or the like; a communication interface; and the like. The host computer 14 operates in accordance with a program and processes various financial transactions regarding the account opened with the financial institution. The host computer 14 can be constructed by a single computer like a large general computer or by organically connecting a plurality of computers like a distributed server, or it can be also one of a plurality of systems constructed in a large computer. Thus, the business processing terminal 23, the automatic cash transaction apparatus 25, or the like of the service office 10 can execute the financial transactions by communicating with the host computer 14.

Reference numeral 30 denotes a centralized control center for managing the processes for the financial transactions accepted from the customer 31 in the service office 10. An acceptance management server 26 and an E-mail server 27 as notifying means are arranged in the center 30. The acceptance management server 26 is a computer having: arithmetic operating means such as CPU, MPU, or the like; storing means such as magnetic disk, semiconductor memory, or the like; input means such as keyboard, mouse, push button, touch panel, or the like; display means such as CRT, liquid crystal display, LED display, or the like; a communication interface; and the like. The acceptance management server 26 communicates with the acceptance-only terminal 21, business processing terminal 23, receiving locker 24, automatic cash transaction apparatus 25, and the like and manages a progressing situation of the processes for the financial transactions accepted from the customer 31.

The E-mail server 27 is a computer having: arithmetic operating means such as CPU, MPU, or the like; storing means such as magnetic disk, semiconductor memory, or the like; input means such as keyboard, mouse, push button, touch panel, or the like; display means such as CRT, liquid crystal display, LED display, or the like; a communication interface; and the like. The E-mail server 27 executes transmission and reception of E-mail, temporary storage of the E-mail, and management of the E-mail. The E-mail server 27 transmits an end notification showing the completion of the processes for the financial transactions accepted from the customer 31 to a customer terminal 16, which will be explained hereinafter.

Reference numeral 17 denotes a network (in the centralized control center) such as Intranet, LAN, or the like constructed in the centralized control center 30. The acceptance management server 26 and the E-mail server 27 are connected to the network 17. Further, the network 17 in the centralized control center is connected to the network 13 and an external network 15 through a router or the like. An arbitrary communication line network such as wired or wireless public communication line network, Intranet, LAN, WAN, satellite communication line network, or the like can be given as an external network 15 or a proper combination of them can be also used. The same network as the network 13 can be also used as an external network 15.

The customer terminal 16 which is operated by the customer 31 is connected to the external network 15. The customer terminal 16 is a kind of computer having: arithmetic operating means such as CPU, MPU, or the like; storing means such as magnetic disk, semiconductor memory, or the like; input means such as keyboard, mouse, joystick, crucial key, push button, remote controller, touch panel, or the like; display means such as CRT, liquid crystal display, LED display, or the like; a communication interface; and the like. Although the customer terminal 16 is, for example, a cellular phone, an arbitrary kind of apparatus can be used so long as it can be connected to the external network 15. That is, it is also possible to use an arbitrary kind of apparatus such as personal computer, PHS (Personal Handy-Phone System) telephone, desk-top telephone, electronic notebook, PDA (Personal Digital Assistant), gaming machine, digital television, or the like. Since the customer terminal 16 has a display apparatus and the like and can communicate with the E-mail server 27, the customer 31 can confirm the contents of the E-mail by displaying the E-mail transmitted from the E-mail server 27 to the display apparatus.

The operation of the acceptance/reception separating system in the financial institution with the above construction will now be described. First, an outline of the operation will be explained.

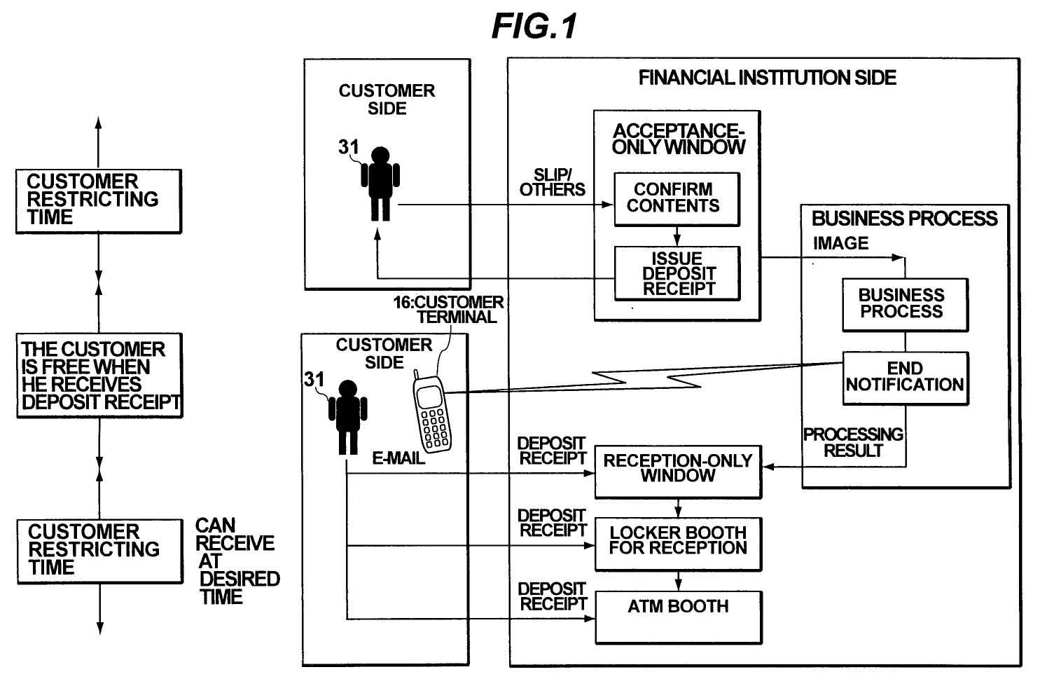

FIG. 1 is a diagram showing the outline of the operation of the acceptance/reception separating system in the financial institution in the first embodiment of the invention.

First, the customer 31 submits the slip 32 on which items necessary to request the process for the financial transaction have been written to the acceptance-only window in the service office 10. Thus, the person in charge at the acceptance-only window receives the slip 32 and, if necessary, the cash 33, the check 34, or the like from the customer 31. The person in charge operates the acceptance-only terminal 21, counts the cash 33, the check 34, or the like, and confirms the contents disclosed on the slip 32. After that, he operates the acceptance-only terminal 21 and obtains the image data of the slip 32.

Subsequently, the person in charge receives the IC card 35 from the customer 31, operates the acceptance-only terminal 21, writes a receipt number into the IC of the IC card 35, and issues a deposit receipt. In this case, the acceptance-only terminal 21 functions as deposit receipt issuing means. The person in charge returns the IC card 35 to the customer 31. At this point of time, the customer 31 becomes free. If there is a problem in the contents disclosed on the slip 32, he returns the slip to the customer 31 and requests him to correct the contents.

Although the IC card 35 is a card which has previously been distributed to the customer 31 by the financial institution, it can be replaced by a dedicated card for issuing the deposit receipt or a card having another card function. For example, if a card such as cash card, credit card, or the like issued by the financial institution is a card having an IC as storing means, such a card can be used as an IC card 35.

Subsequently, the image data of the slip 32 is transmitted to the business processing terminal 23. The person in charge who processes the businesses in the service office 10 operates the business processing terminal 23 and executes the process for the financial transaction requested by the customer 31, that is, the business process in accordance with the contents disclosed on the slip 32. After completion of the business process, a transaction result of the financial transaction is transmitted to the acceptance management server 26. The acceptance management server 26 receives the transaction result and if it is determined that it is necessary to notify the customer 31 of it, the server 26 transmits the transaction result to the E-mail server 27. Thus, the E-mail server 27 forms E-mail including the transaction result as an end notification and transmits it to the customer terminal 16. The end notification can be made by a voice speech through a telephone, by being displayed on a distributing board arranged in the service office 10, or by updating information shown in a homepage on the Internet. The customer 31 does not make the end notification but can preliminarily designate a term and execute the business process until the appointed term.

When the customer 31 receives the end notification or after the expiration of the designated term, he visits the reception-only window and gets the slip 32 on which the processing result has been written in exchange for the deposit receipt if it is the timing before the end of the business hours of the service office 10. In this case, the person in charge at the reception-only window receives the IC card 35 from the customer 31, operates the reception-only terminal 22, and reads out the receipt number written in the IC of the IC card 35, thereby receiving the deposit receipt.

After the end of the business hours of the service office 10, the customer 31 visits the receiving locker booth and gets the slip 32 on which the processing result has been written in exchange for the deposit receipt. In this case, the customer 31 operates an operation display apparatus of the receiving locker 24 by himself, allows the control unit of the receiving locker 24 to read out a receipt number written in the IC of the IC card 35 and open a locker door of the corresponding box by using the receipt number as a key, and gets the slit 32 enclosed in the box.

The customer 31 can also visit the ATM booth and receive the slip 32 on which the processing result has been written and the cash 33 in exchange for the deposit receipt. In this case, the customer 31 operates the customer operation unit of the automatic cash transaction apparatus 25 by himself, allows the automatic cash transaction apparatus 25 to read out the receipt number written in the IC of the IC card 35, and can receive the slip 32 and the cash 33 by using the receipt number as a key.

The operation upon acceptance will now be described in detail.

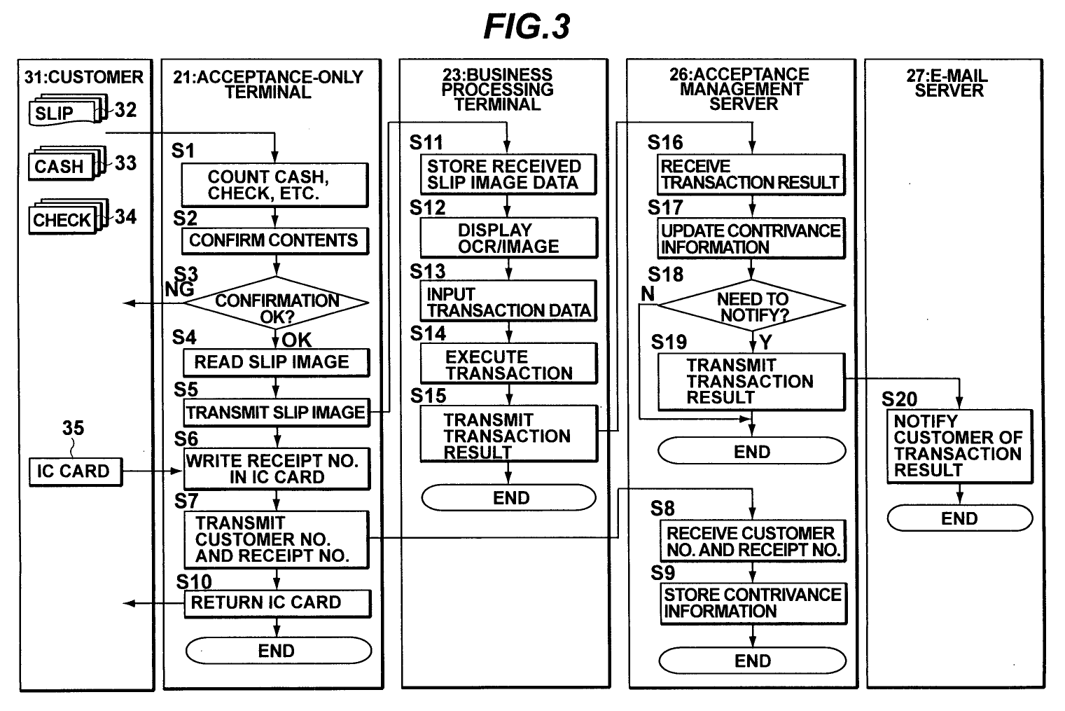

FIG. 3 is a flowchart showing the operation at the time of acceptance in the acceptance/reception separating system in the financial institution in the first embodiment of the invention.

First, when the customer 31 submits the slip 32 on which items necessary to request the process for the financial transaction have been written, and the cash 33, the check 34, or the like to the acceptance-only window in the service office 10, the person in charge at the acceptance-only window operates the acceptance-only terminal 21 and counts the cash 33, the check 34, or the like. Subsequently, contents confirmation is made and the contents disclosed on the slip 32 are confirmed by the person in charge. Whether or not a confirmation acknowledgment (OK) has been obtained, that is, whether or not the disclosed contents are correct is discriminated.

If there is a problem in the disclosed contents or the like on the slip 32 and the confirmation OK is not obtained, the slip 32 is returned to the customer 31. If the confirmation OK is obtained, the person in charge operates the acceptance-only terminal 21, reads out the image data of the slip, and obtains the image data of the slip 32. The slip image transmission is performed and the image data of the slip 32 is transmitted from the acceptance-only terminal 21 to the business processing terminal 23.

Subsequently, the person in charge receives the IC card 35 from the customer 31, operates the acceptance-only terminal 21, executes the writing of the IC card receipt number, and writes the receipt number into the IC of the IC card 35. Thus, transmission of the customer number and the receipt number is executed and the customer number of the customer 31 and the receipt number are transmitted from the acceptance-only terminal 21 to the acceptance management server 26. When the person in charge returns the IC card 35 to the customer 31, the processes in the acceptance-only terminal 21 are finished.

Subsequently, the business processing terminal 23 executes storage of the reception image data of the slip and stores the image data of the slip 32 received from the acceptance-only terminal 21 into the storing means. When the person in charge who processes the businesses in the service office 10 operates the business processing terminal 23 and executes an OCR/image display, the characters written on the slip 32 and the image data of the slip 32 recognized by the OCR function are displayed on the display apparatus of the business processing terminal 23.

Subsequently, the person in charge operates the business processing terminal 23, executes transaction data input on the basis of the contents displayed on the display apparatus, and inputs the data necessary for the financial transaction requested by the customer 31. The business processing terminal 23 executes the transaction, communicates with the host computer 14, and executes the financial transaction. Subsequently, after the end of the process for the financial transaction, that is, the business process, transaction result transmission is executed and the transaction result as a result of the financial transaction is transmitted to the acceptance management server 26. The processes in the business processing terminal 23 are finished.

Subsequently, the acceptance management server 26 executes reception of the customer number and the receipt number and receives the customer number of the customer 31 and the receipt number from the acceptance-only terminal 21. The acceptance management server 26 executes contrivance information storage, stores the contrivance information of the customer 31 into the storing means, and finishes the processing routine for the time being. The contrivance information is information indicative of a progressing situation of the business for the financial transaction requested by the customer 31, that is, a progressing situation of the business process. When the business processing terminal 23 transmits the transaction result, the acceptance management server 26 executes transaction result reception and receives the transaction result as a result of the financial transaction from the business processing terminal 23.

Subsequently, the acceptance management server 26 executes contrivance information updating and updates the stored contrivance information. In this case, the contrivance information is updated so as to reflect the completion of the business process. Thus, the acceptance management server 26 discriminates about the necessity of notification, that is, whether or not it is necessary to notify the customer 31 of the transaction result. If the notification is necessary, the acceptance management server 26 executes transaction result transmission, transmits the transaction result as a result of the financial transaction to the E-mail server 27, and finishes the processing routine. If the notification is unnecessary, the processing routine is finished as it is.

Subsequently, the E-mail server 27 notifies the relevant customer of the transaction result, forms the E-mail including the transaction result received from the acceptance management server 26 as an end notification, transmits it to the customer terminal 16 of the customer 31, and finishes the processing routine.

The flowchart will now be described.
Step S1: The acceptance-only terminal 21 is operated and the cash 33, the check 34, or the like is counted.
Step S2: The person in charge confirms the contents.
Step S3: Whether or not the confirmation OK has been obtained is discriminated. If the confirmation OK is not obtained, the slip is returned to the customer. If the confirmation OK has been obtained, the processing routine advances to step S4.
Step S4: The acceptance-only terminal 21 is operated and the image data of the slip is read out.
Step S5: The acceptance-only terminal 21 transmits the image data of the slip 32 to the business processing terminal 23.
Step S6: The person in charge receives the IC card 35 which has previously been distributed to the customer 31, operates the acceptance-only terminal 21, and writes the receipt number into the IC card 35.
Step S7: The customer number and the receipt number are transmitted from the acceptance-only terminal 21 to the acceptance management server 26.
Step S8: The acceptance management server 26 receives the customer number and the receipt number.
Step S9: The acceptance management server 26 stores the contrivance information and finishes the processing routine.
Step S10: The acceptance-only terminal 21 returns the IC card 35 to the customer and finishes the processing routine.
Step S11: The business processing terminal 23 stores the reception image data of the slip.
Step S12: The business processing terminal 23 executes the OCR/image display.
Step S13: The business processing terminal 23 inputs the transaction data.
Step S14: The business processing terminal 23 executes the transaction.
Step S15: The business processing terminal 23 transmits the transaction result to the acceptance management server 26 and finishes the processing routine.
Step S16: The acceptance management server 26 receives the transaction result.
Step S17: The acceptance management server 26 updates the contrivance information.
Step S18: The acceptance management server 26 discriminates whether or not it is necessary to notify the customer. If it is necessary to notify the customer, step S19 follows. If it is unnecessary to notify the customer, the processing routine is finished.
Step S19: The acceptance management server 26 transmits the transaction result to the E-mail server 27 and finishes the processing routine.
Step S20: The E-mail server 27 notifies the relevant customer 31 of the transaction result and finishes the processing routine.

The operation at the time of reception will now be described.

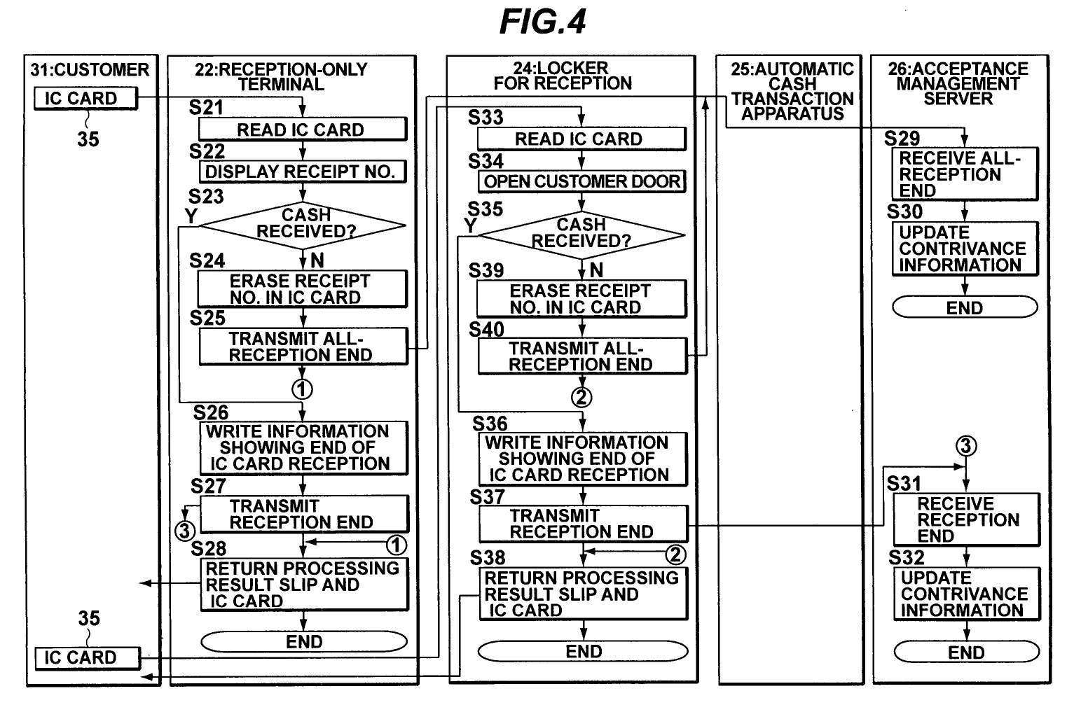

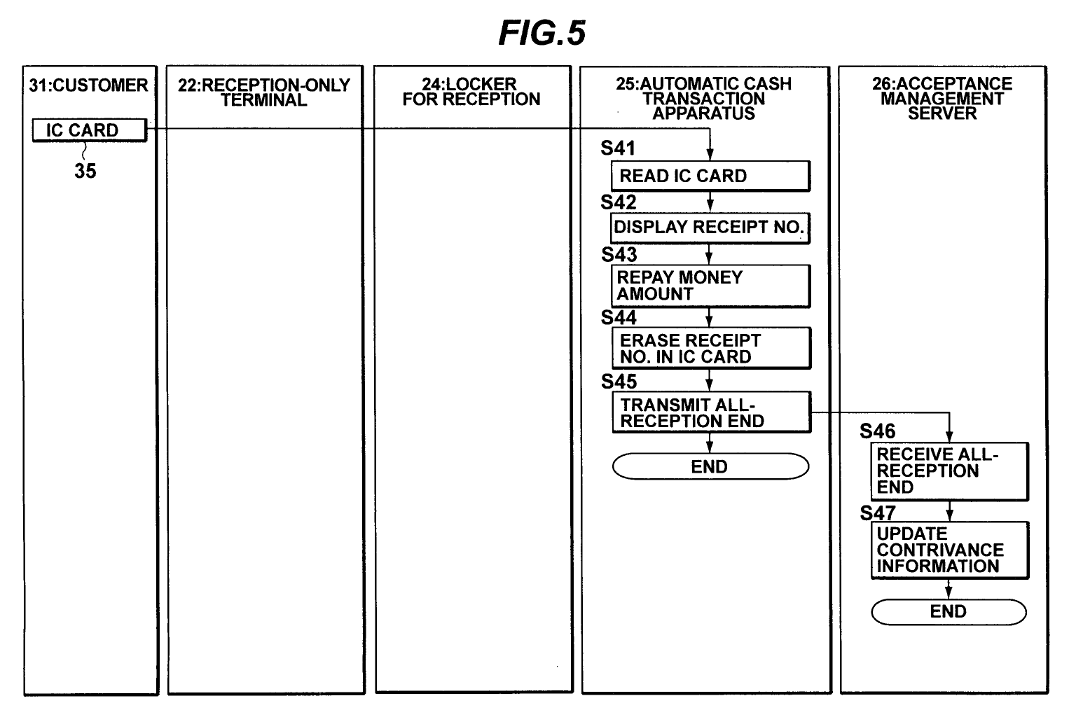

FIG. 4 is a first flowchart showing the operation at the time of reception in the acceptance/reception separating system in the financial institution in the first embodiment of the invention. FIG. 5 is a second flowchart showing the operation at the time of reception in the acceptance/reception separating system in the financial institution in the first embodiment of the invention.

First, the case where the customer 31 who received the end notification visits the reception-only window will be described. In this case, when the customer 31 submits the IC card 35 to the reception-only window, the person in charge at the reception-only window operates the reception-only terminal 22, reads out the IC card, and reads out the receipt number written in the IC of the IC card 35, thereby allowing the receipt number to be displayed on the display apparatus. Subsequently, whether or not the cash reception is performed, that is, whether or not the customer 31 receives the cash 33 as a result of the financial transaction is discriminated. If there is no cash reception, the reception-only terminal 22 executes the IC card receipt number erasure and erases the receipt number written in the IC of the IC card 35. Thus, all-reception end transmission is executed and a notification showing that the customer 31 has received all items to be received as a result of the financial transaction is transmitted from the reception-only terminal 22 to the acceptance management server 26.

Subsequently, the person in charge executes the return of the processing result slip and the IC card, returns the slip 32 on which the processing result has been written to the customer 31, returns the IC card 35, and finishes the processing routine.

If there is the cash reception, the reception-only terminal 22 executes the writing of the IC card reception end information and writes information showing that the customer 31 has received the items to be received, other than the cash 33, as a result of the financial transaction into the IC of the IC card 35. Thus, reception end transmission is executed. A notification showing that the customer 31 has received the items to be received, other than the cash 33, as a result of the financial transaction is transmitted from the reception-only terminal 22 to the acceptance management server 26. The processing result slip and the IC card are returned.

Subsequently, if the reception-only terminal 22 executed the all-reception end transmission, the acceptance management server 26 executes all-reception end reception and receives the notification showing that the customer 31 has received all of the items to be received as a result of the financial transaction from the reception-only terminal 22. The acceptance management server 26 executes contrivance information updating, updates the stored contrivance information, and finishes the processing routine. In this case, the contrivance information is updated so as to reflect the information showing that the customer 31 has received all of the items to be received as a result of the financial transaction.

When the reception-only terminal 22 executes the reception end transmission, the acceptance management server 26 executes reception end reception and receives the notification showing that the customer 31 has received all of the items to be received, other than the cash, as a result of the financial transaction from the reception-only terminal 22. The acceptance management server 26 executes the contrivance information updating, updates the stored contrivance information, and finishes the processing routine. In this case, the contrivance information is updated so as to reflect the information showing that the customer 31 has received the items to be received, other than the cash 33, as a result of the financial transaction.

The case where the customer 31 who received the end notification visits the receiving locker booth will now be described. In this case, the customer 31 operates an operation display apparatus of the receiving locker 24 by himself and allows the control unit of the receiving locker 24 to read the IC card 35. Thus, the receipt number written in the IC of the IC card 35 is read out by the control unit, opening of the relevant customer door is executed, and the locker door of the relevant box is opened by using the receipt number as a key. Subsequently, the control unit of the receiving locker 24 discriminates whether or not there is a cash reception, that is, whether or not the customer 31 receives the cash 33 as a result of the financial transaction. If there is not the cash reception, the control unit of the receiving locker 24 executes the IC card receipt number erasure and erases the receipt number written in the IC of the IC card. Thus, all-reception end transmission is executed and the notification showing that the customer 31 has received all of the items to be received as a result of the financial transaction is transmitted from the control unit of the receiving locker 24 to the acceptance management server 26.

Subsequently, the return of the processing result slip and the IC card is executed, the customer 31 receives the slip 32 on which the processing result has been written and the IC card 35 which have been enclosed in the corresponding box, and the processing routine is finished.

If there is the cash reception, the control unit of the receiving locker 24 executes the writing of the IC card reception end information and writes the information showing that the customer 31 has received the items to be received, other than the cash 33, as a result of the financial transaction into the IC of the IC card 35. Thus, the reception end transmission is executed. The notification showing that the customer 31 has received the items to be received, other than the cash 33, as a result of the financial transaction is transmitted from the control unit of the receiving locker 24 to the acceptance management server 26. The processing result slip and the IC card are returned.

Since the operation of the acceptance management server 26 is similar to that in the case where the customer 31 who received the end notification visits the reception-only window, its explanation is omitted here.

The case where the customer 31 who received the end notification visits an ATM booth will now be described. In this case, the customer 31 operates a customer operation unit of the automatic cash transaction apparatus 25 by himself and allows the automatic cash transaction apparatus 25 to execute the IC card reading. Thus, the receipt number written in the IC of the IC card 35 is read out and displayed on the display apparatus, and the receipt number display is executed. Subsequently, the automatic cash transaction apparatus 25 executes the repayment of the money amount and repays the cash 33 to be received by the customer 31 as a result of the financial transaction from the money payment/withdrawal unit. Subsequently, the automatic cash transaction apparatus 25 executes the IC card receipt number erasure and erases the receipt number written in the IC of the IC card 35. Thus, the all-reception end transmission is executed, the notification showing that the customer 31 has received all items to be received as a result of the financial transaction is transmitted from the automatic cash transaction apparatus 25 to the acceptance management server 26, and the processing routine is finished.

The acceptance management server 26 executes the all-reception end reception and receives the notification showing that the customer 31 has received all of the items to be received as a result of the financial transaction from the automatic cash transaction apparatus 25. The acceptance management server 26 executes the contrivance information updating, updates the stored contrivance information, and finishes the processing routine. In this case, the contrivance information is updated so as to reflect the information showing that the customer 31 has received all of the items to be received as a result of the financial transaction.

A flowchart will now be described.
Step S21: The reception-only terminal 22 receives the IC card 35 from the customer and reads out the IC card data.
Step S22: The reception-only terminal 22 displays the receipt number.
Step S23: The reception-only terminal 22 discriminates whether or not there is a cash reception. If there is the cash reception, step S26 follows. If there is not the cash reception, step S24 follows.
Step S24: The reception-only terminal 22 erases the receipt number in the IC card.
Step S25: The reception-only terminal 22 transmits the all-reception end to the acceptance management server 26
Step S26: The reception-only terminal 22 writes the IC card reception end information.
Step S27: The reception-only terminal 22 transmits the reception end to the acceptance management server 26.
Step S28: The reception-only terminal 22 returns the processing result slip and the IC card and finishes the processing routine.
Step S29: The acceptance management server 26 receives the all-reception end.
Step S30: The contrivance information is updated and the processing routine is finished.
Step S31: The acceptance management server 26 receives the reception end.
Step S32: The acceptance management server 26 updates the contrivance information and finishes the processing routine.
Step S33: The receiving locker 24 reads the IC card.
Step S34: The receiving locker 24 opens the relevant customer door.
Step S35: The receiving locker 24 discriminates whether or not there is a cash reception. If the cash was received, step S36 follows. If there is not a cash reception, step S39 follows.
Step S36: The receiving locker 24 writes the IC card reception end information.
Step S37: The receiving locker 24 transmits the reception end to the acceptance management server 26.
Step S38: The receiving locker 24 returns the processing result slip and the IC card and finishes the processing routine.
Step S39: The receiving locker 24 erases the receipt number in the IC card.
Step S40: The receiving locker 24 transmits the all-reception end to the acceptance management server 26.
Step S41: The automatic cash transaction apparatus 25 receives the IC card 35 from the customer 31 and reads the IC card.
Step S42: The automatic cash transaction apparatus 25 displays the receipt number.
Step S43: The automatic cash transaction apparatus 25 repays the corresponding money amount.
Step S44: The automatic cash transaction apparatus 25 erases the receipt number in the IC card.
Step S45: The automatic cash transaction apparatus 25 transmits the all-reception end to the acceptance management server 26 and finishes the processing routine.
Step S46: The acceptance management server 26 receives the all-reception end.
Step S47: The acceptance management server 26 updates the contrivance information and finishes the processing routine.

As mentioned above, in the embodiment, when the process for the financial transaction is accepted at the acceptance-only window, by writing the receipt number into the IC of the IC card 35, the deposit receipt is issued to the customer 31. When the process for the financial transaction, that is, the business process is executed and finished, the end notification is transmitted to the customer terminal 16. Thus, the customer 31 visits the reception-only window, the receiving locker booth, or the ATM booth and can receive the result of the process for the financial transaction in exchange for the deposit receipt.

Therefore, the acceptance of the process for the financial transaction and the reception of the result of the process for the financial transaction are separated. The customer 31 does not need to wait until he receives the result of the process for the financial transaction. Since the result of the process for the financial transaction is received after the elapse of a time, the financial institution can efficiently execute the business process.

Further, by operating the receiving locker 24 or the automatic cash transaction apparatus 25 by the customer 31 himself, even after the end of the business hours of the window in the service office 10, the customer 31 can receive the result of the process for the financial transaction. In other words, he can receive the result of the process for the financial transaction at desired timing. Since the financial institution does not need to open the window in the service office 10 out of the business hours, the costs can be reduced.

The second embodiment of the invention will now be described. Component elements having substantially the same construction as that of the first embodiment are designated by the same reference numerals and their description is omitted here. Explanation of the same operations and effects as those in the first embodiment is also omitted here.

In the embodiment, in place of the IC card 35, a certificate with an IC tag is issued as a deposit receipt at the acceptance-only window. In this case, the customer 31 receives a key of the receiving locker 24 together with the certificate with the IC tag at the acceptance-only window. For this purpose, the customer 31 operates the receiving locker 24 by himself and receives the result of the process for the financial transaction.

In place of the certificate with the IC tag, the IC card 35 can be also issued at the acceptance-only window. In this case, the IC card 35 is collected when the customer receives the result of the process for the financial transaction. Thus, even if the customer 31 does not open an account with the financial institution or is not a member of the financial institution, he can use the acceptance/reception separating system in the financial institution in the embodiment.

The third embodiment of the invention will now be described. Component elements having substantially the same construction as that of the first and second embodiments are designated by the same reference numerals and their description is omitted here. Explanation of the same operations and effects as those in the first and second embodiments is also omitted here.

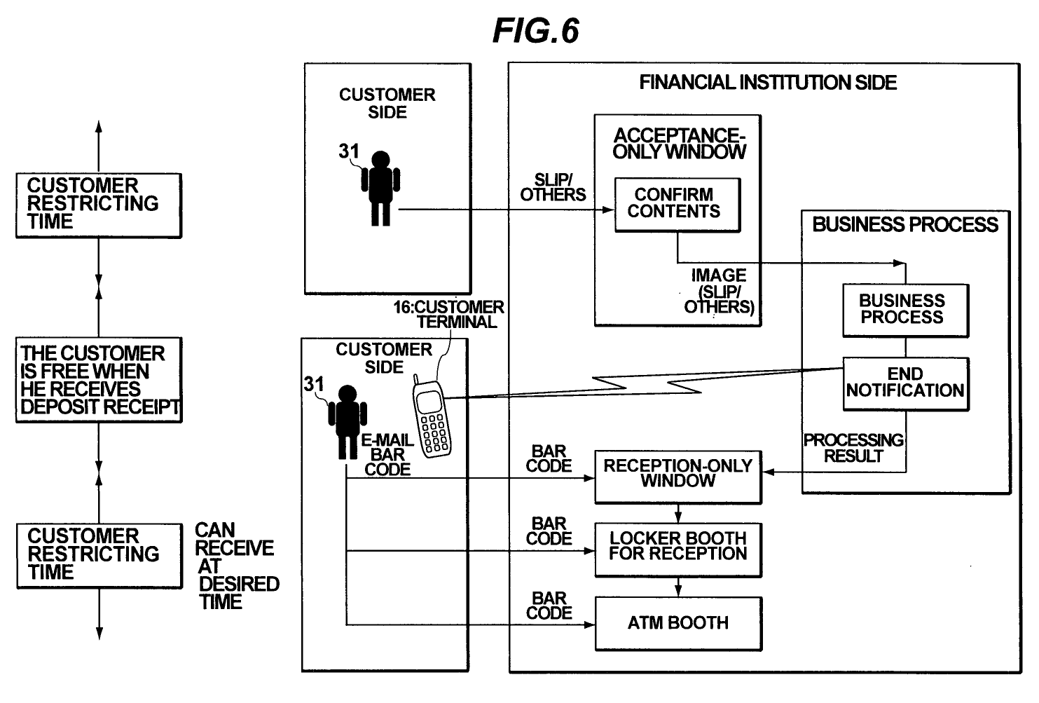

FIG. 6 is a diagram showing an outline of the operation of an acceptance/reception separating system in a financial institution in the third embodiment of the invention.

In this embodiment, as shown in FIG. 6, when the process for the financial transaction is accepted at the acceptance-only window, the deposit receipt is not issued but at a point of time when the process for the financial transaction, that is, the business process is finished, the deposit receipt is issued at the time of notification of the end of the business process. In this case, a bar code is transmitted to the customer terminal 16 and written into the storing means of the customer terminal 16, thereby issuing the deposit receipt. Therefore, the IC card 35 is unnecessary. By locking the customer terminal 16, a security can be also improved.

The fourth embodiment of the invention will now be described. Component elements having substantially the same construction as that of the first to third embodiments are designated by the same reference numerals and their description is omitted here. Explanation of the same operations and effects as those in the first to third embodiments is also omitted here.

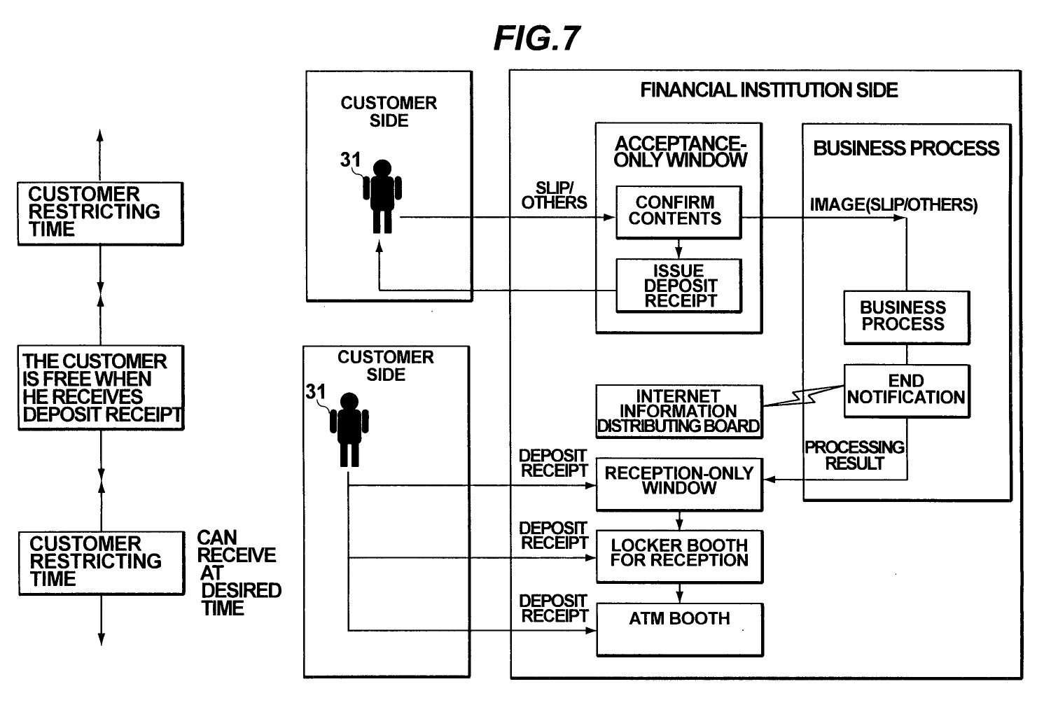

FIG. 7 is a diagram showing an outline of the operation of an acceptance/reception separating system in a financial institution in the fourth embodiment of the invention.

In this embodiment, as shown in FIG. 7, the end notification is not transmitted as E-mail to the customer terminal 16 but Internet information as information which is written in a homepage on the Internet is updated or displayed on the distributing board arranged in the service office 10, thereby performing the end notification. Therefore, the customer 31 can grasp the end of the business process with reference to the Internet information or the distributing board at desired timing. Although there is also a case where the end notification is not sent to the customer terminal 16 in the case of the E-mail, even in such a case, according to the embodiment, the E-mail can be covered by the Internet information or the distributing board.

The fifth embodiment of the invention will now be described. Component elements having substantially the same construction as that of the first to fourth embodiments are designated by the same reference numerals and their description is omitted here. Explanation of the same operations and effects as those in the first to fourth embodiments is also omitted here.

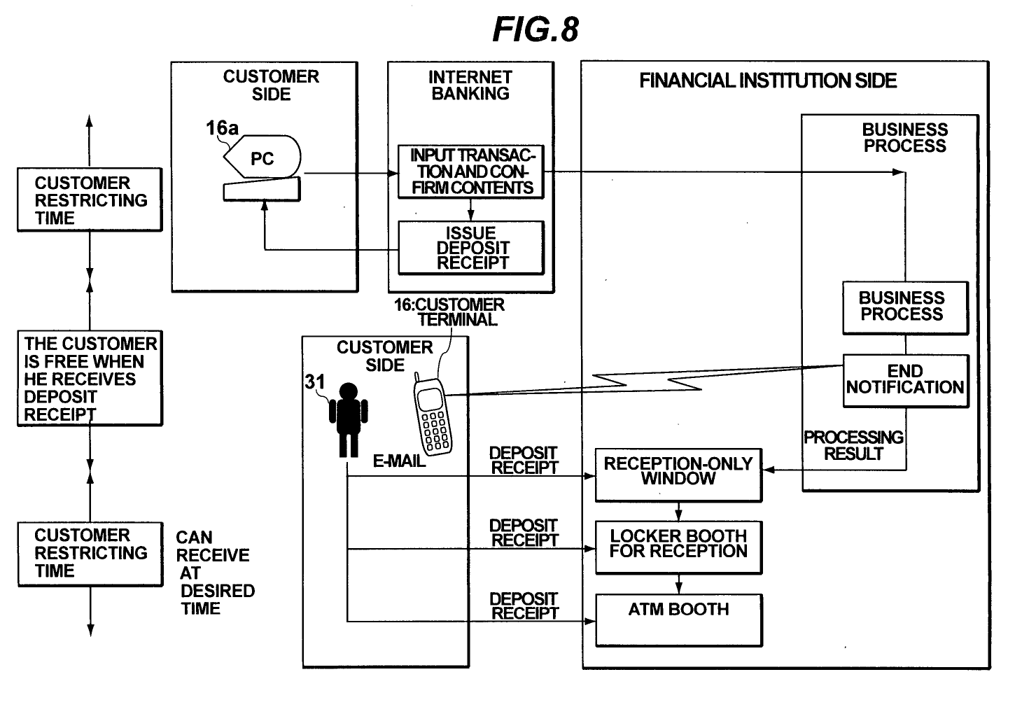

FIG. 8 is a diagram showing an outline of the operation of an acceptance/reception separating system in a financial institution in the fifth embodiment of the invention.

In this embodiment, as shown in FIG. 8, the customer 31 does not visit the acceptance-only window in the service office 10 but requests the process for the financial transaction by Internet banking provided by the financial institution. In this case, the customer 31 requests the process for the financial transaction by using an Internet terminal 16a.

The Internet terminal 16a is a kind of computer having: arithmetic operating means such as CPU, MPU, or the like; storing means such as magnetic disk, semiconductor memory, or the like; input means such as keyboard, mouse, joystick, crucial key, push button, remote controller, touch panel, or the like; display means such as CRT, liquid crystal display, LED display, or the like; a communication interface; and the like. Although the Internet terminal 16a is, for example, a personal computer, an arbitrary kind of apparatus can be used so long as it can be connected to the Internet. That is, it is also possible to use an any one of a cellular phone, a PHS telephone, a desk-top telephone, an electronic notebook, a PDA, a gaming machine, a digital television, and the like. The Internet terminal 16a can be also the same as the customer terminal 16.

Thus, The customer 31 does not need to visit the service office 10 in order to request the process for the financial transaction.

The sixth embodiment of the invention will now be described. Component elements having substantially the same construction as that of the first to fifth embodiments are designated by the same reference numerals and their description is omitted here. Explanation of the same operations and effects as those in the first to fifth embodiments is also omitted here.

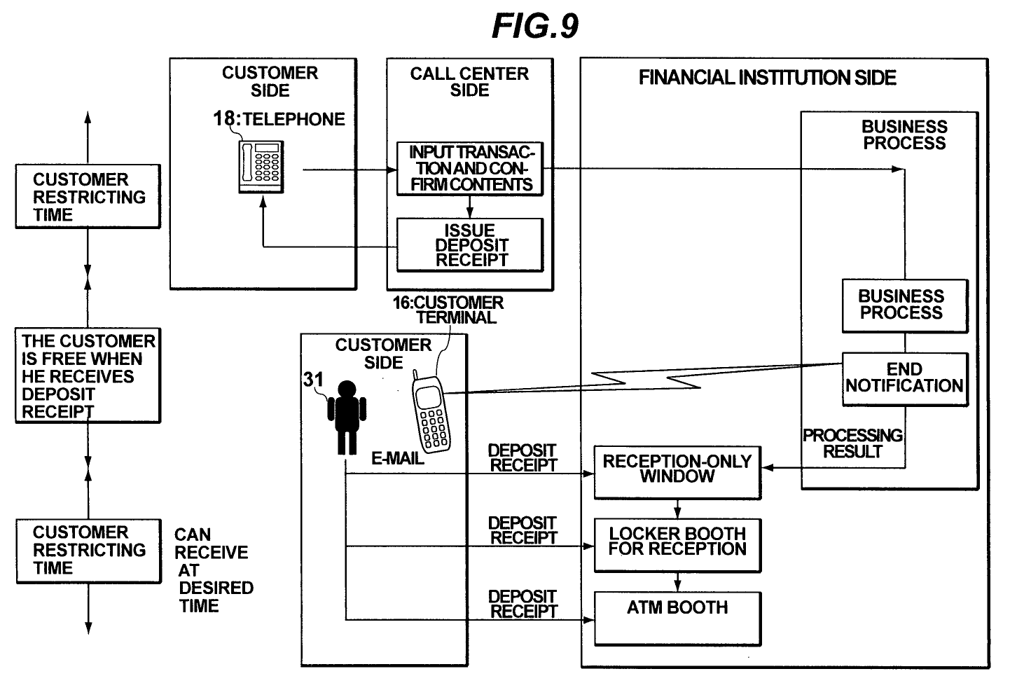

FIG. 9 is a diagram showing an outline of the operation of an acceptance/reception separating system in a financial institution in the sixth embodiment of the invention.

In this embodiment, as shown in FIG. 9, the customer 31 does not visit the acceptance-only window in the service office 10 but requests the process for the financial transaction by telephone by using a call center provided by the financial institution. In this case, the customer 31 requests the process for the financial transaction by inputting necessary numbers or making a voice speech with the operator by using a telephone 18 such as a push-phone or the like. Thus, the customer 31 does not need to visit the service office 10 in order to request the process for the financial transaction.

The seventh embodiment of the invention will now be described. Component elements having substantially the same construction as that of the first to sixth embodiments are designated by the same reference numerals and their description is omitted here. Explanation of the same operations and effects as those in the first to sixth embodiments is also omitted here.

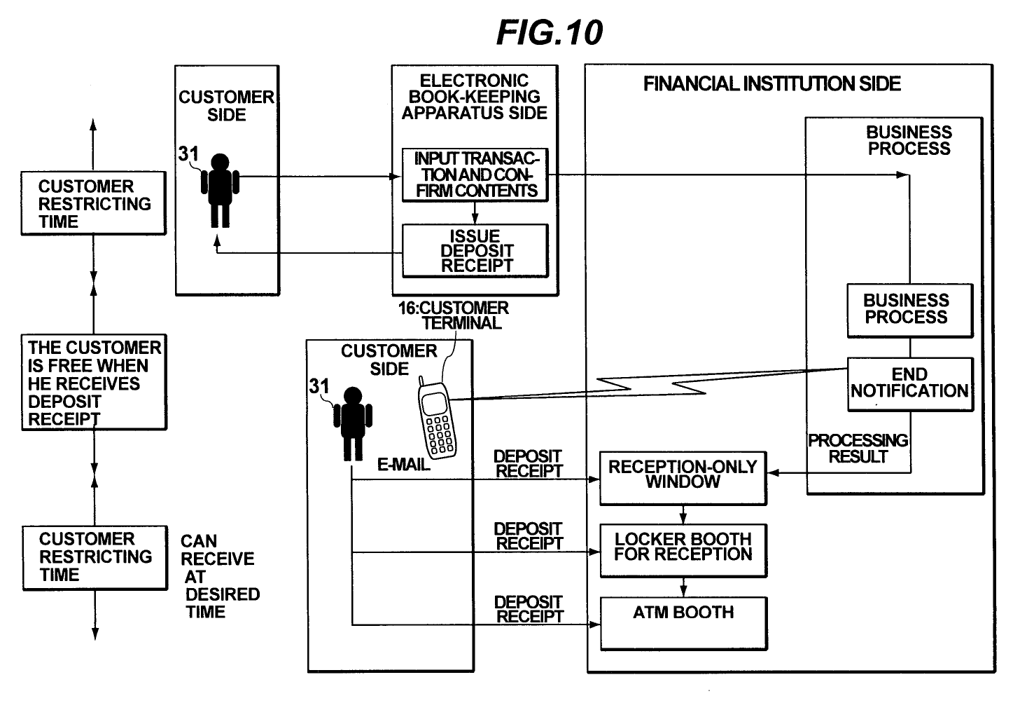

FIG. 10 is a diagram showing an outline of the operation of an acceptance/reception separating system in a financial institution in the seventh embodiment of the invention.

In this embodiment, as shown in FIG. 10, the customer 31 does not visit the acceptance-only window in the service office 10 but requests the process for the financial transaction by an electronic book-keeping apparatus which is provided by the financial institution and arranged in the home or at a place near his workplace. Thus, the customer 31 does not need to visit the service office 10 in order to request the process for the financial transaction.

The eighth embodiment of the invention will now be described. Component elements having substantially the same construction as that of the first to seventh embodiments are designated by the same reference numerals and their description is omitted here. Explanation of the same operations and effects as those in the first to seventh embodiments is also omitted here.

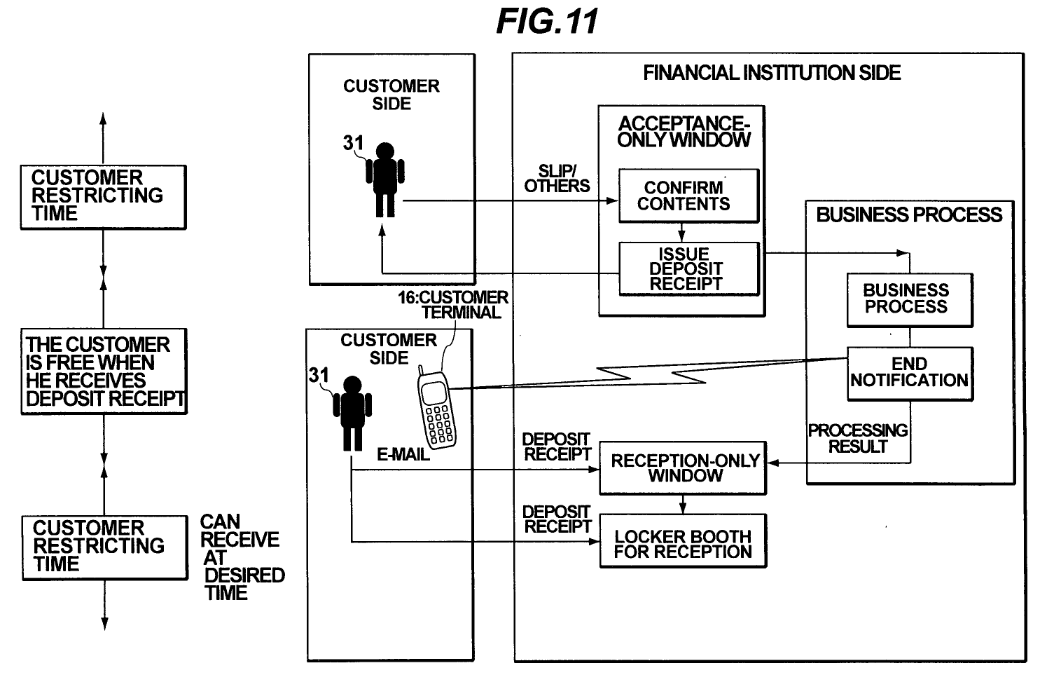

FIG. 11 is a diagram showing an outline of the operation of an acceptance/reception separating system in a financial institution in the eighth embodiment of the invention.

In this embodiment, as shown in FIG. 11, the ATM booth is omitted. In this case, the customer 31 receives the result of the process for the financial transaction at the acceptance-only window or the receiving locker booth. Therefore, since the customer 31 does not need to operate the automatic cash transaction apparatus 25 in the ATM booth by himself, a burden of the operation on the customer 31 can be reduced and his waiting time can be shortened.

The ninth embodiment of the invention will now be described. Component elements having substantially the same construction as that of the first to eighth embodiments are designated by the same reference numerals and their description is omitted here. Explanation of the same operations and effects as those in the first to eighth embodiments is also omitted here.

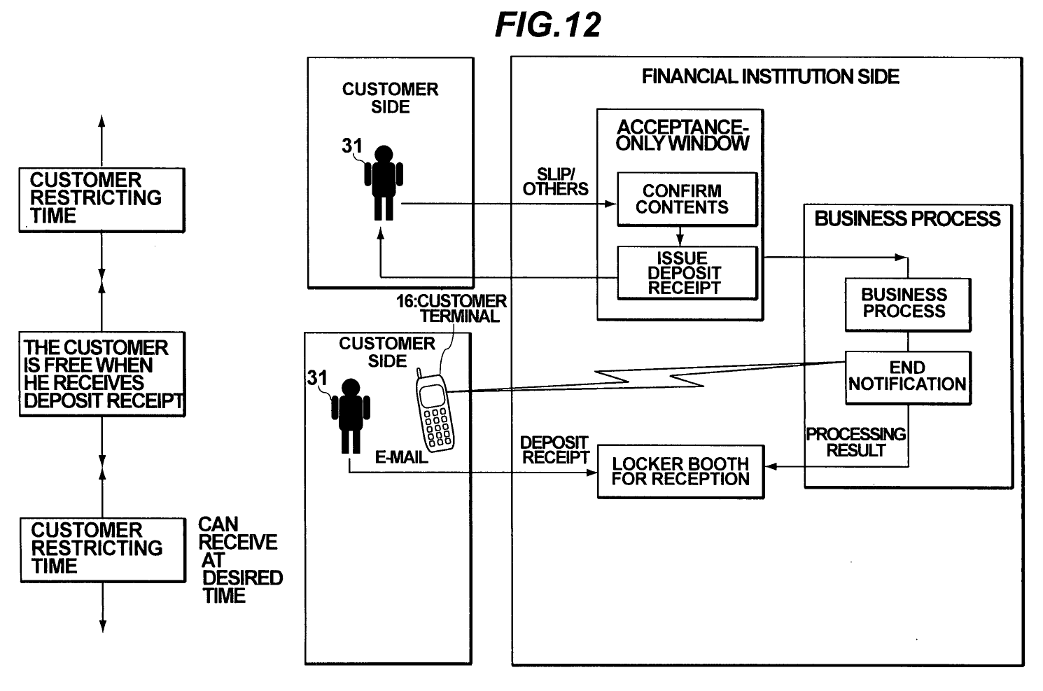

FIG. 12 is a diagram showing an outline of the operation of an acceptance/reception separating system in a financial institution in the ninth embodiment of the invention.

In this embodiment, as shown in FIG. 12, the acceptance-only window and the ATM booth are omitted. In this case, the customer 31 receives the result of the process for the financial transaction by using the receiving locker 24 at the receiving locker booth. Therefore, the financial institution can reduce a burden for maintaining the acceptance-only window and the ATM booth.

The tenth embodiment of the invention will now be described. Component elements having substantially the same construction as that of the first to ninth embodiments are designated by the same reference numerals and their description is omitted here. Explanation of the same operations and effects as those in the first to ninth embodiments is also omitted here.

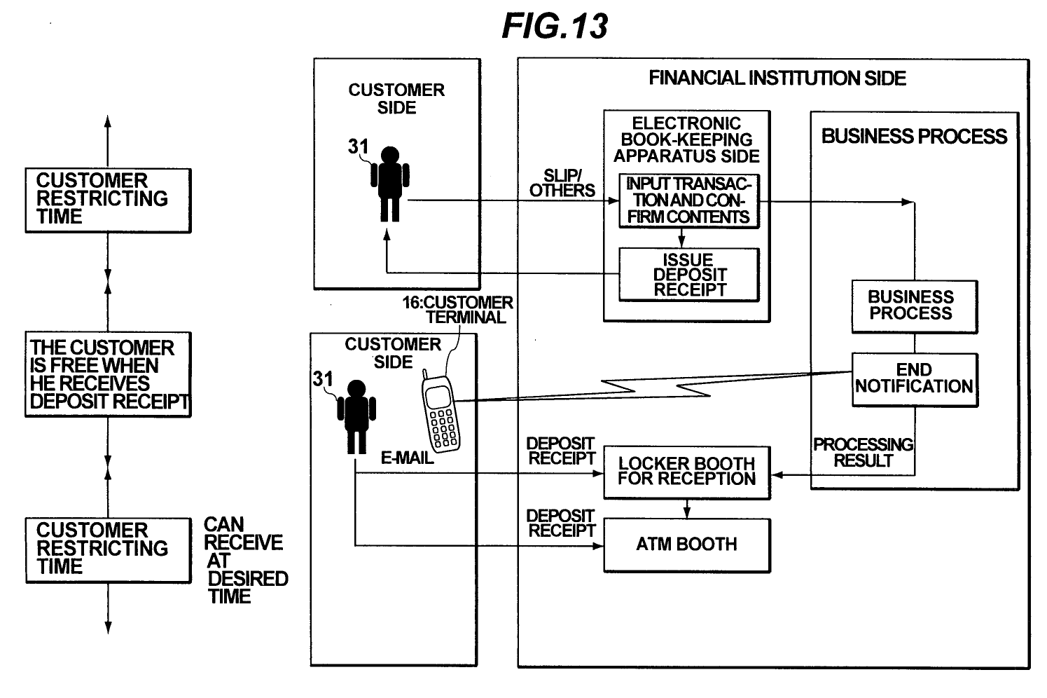

FIG. 13 is a diagram showing an outline of the operation of an acceptance/reception separating system in a financial institution in the tenth embodiment of the invention.

In this embodiment, as shown in FIG. 13, the acceptance-only window is omitted. In this case, the customer 31 receives the result of the process for the financial transaction by using the receiving locker 24 at the receiving locker booth or by using the automatic cash transaction apparatus 25 at the ATM booth. Therefore, the financial institution can reduce the burden for maintaining the acceptance-only window and can keep the security.

The invention is not limited to the foregoing embodiments but many modifications and variations are possible on the basis of the spirit of the invention and they are not excluded from the scope of the invention.

1. An acceptance/reception separating system in a financial institution, comprising:
accepting means which accepts a process for a financial transaction;
deposit receipt issuing means which issues a deposit receipt showing that said process has been accepted;
business processing means which executes said process;
notifying means which notifies said system of an end of said process; and
receiving means which confirms a personal identification by said deposit receipt and enables a result of said process to be received,
wherein the acceptance of said process and the reception of the result of said process are separately executed.

2. The acceptance/reception separating system according to claim 1, wherein said deposit receipt issuing means issues the deposit receipt by writing a receipt number into an IC card.

3. The acceptance/reception separating system according to claim 1, wherein said notifying means notifies said system of the end of said process by transmitting E-mail to a customer terminal.

4. The acceptance/reception separating system according to claim 1, wherein said receiving means is a reception-only terminal, a locker for reception, or an automatic cash transaction apparatus.

5. The acceptance/reception separating system according to claim 1, wherein said deposit receipt is a certificate with an IC tag.

6. The acceptance/reception separating system according to claim 1, wherein said deposit receipt is issued when the end of said process is notified.

7. The acceptance/reception separating system according to claim 1, wherein said notifying means notifies said system of the end of said process by updating Internet information or displaying it onto a distributing board.

8. The acceptance/reception separating system according to claim 1, wherein said accepting means accepts said process by Internet banking.

9. The acceptance/reception separating system according to claim 1, wherein said accepting means accepts said process by telephone.

10. The acceptance/reception separating system according to claim 1, wherein said accepting means accepts said process by an electronic book-keeping apparatus.

11. The acceptance/reception separating system according to claim 1, wherein said receiving means is a reception-only terminal or a locker for reception.

12. The acceptance/reception separating system according to claim 1, wherein said receiving means is a locker for reception.

13. The acceptance/reception separating system according to claim 1, wherein said receiving means is a locker for reception or an automatic cash transaction apparatus.
